(19) United States
(12) Patent Application Publication
(10) Pub. No.: US 2018/0351977 A1
(43) Pub. Date: Dec. 6, 2018

(54) Systems and Methods of Malicious Domain Identification

(71) Applicant: COX COMMUNICATIONS, INC., Atlanta, GA (US)

(72) Inventor: Matthew Edwin Carothers, Dunwoody, GA (US)

(73) Assignee: COX COMMUNICATIONS, INC., Atlanta, GA (US)

(21) Appl. No.: 15/612,591

(22) Filed: Jun. 2, 2017

(51) Int. Cl. H04L 29/06; H04L 29/12; G06F 21/56

(52) U.S. Cl. CPC H04L 63/1425; G06F 21/56; H04L 63/1408; H04L 61/1511

(57) ABSTRACT

Example embodiments of the systems and methods of malicious domain identification disclosed herein considers a first group of users. The first group of users has traffic including some traffic with malicious domains. A second group of users is then selected with traffic that is known to be uninfected, and the common domains are determined. The second group of users, who are known to be uninfected users, are accessing some of the same domains as the first group, among others, but are not accessing the malicious domains. Traffic from the second group of users will have the same commonalities between each other as the malicious domain does with the second group. The common domains between the first and second groups are determined and eliminated. When the common domains are removed from the traffic of the first group of users, malicious domain list remains.

### TECHNICAL FIELD

The present disclosure is generally related to internet traffic and, more particularly, is related to identifying malicious internet domains.

### BACKGROUND

The Domain Name System (DNS) is a hierarchical decentralized naming system for computers, services, or other resources connected to the Internet or a private network. It associates various information with domain names assigned to each of the participating entities. Most prominently, it translates more readily memorized domain names to the numerical IP addresses needed for locating and identifying computer services and devices with the underlying network protocols. By providing a worldwide, distributed directory service, the Domain Name System is an essential component of the functionality of the Internet that has been in use since 1985.

The Domain Name System delegates the responsibility of assigning domain names and mapping those names to Internet resources by designating authoritative name servers for each domain. Network administrators may delegate authority over sub-domains of their allocated name space to other name servers. This mechanism provides distributed and fault tolerant service and was designed to avoid a single large central database.

The Domain Name System also specifies the technical functionality of the database service that is at its core. It defines the DNS protocol, a detailed specification of the data structures and data communication exchanges used in the DNS, as part of the Internet Protocol Suite. Historically, other directory services preceding DNS were not scalable to large or global directories as they were originally based on text files, prominently the HOSTS.TXT resolver.

The Internet maintains two principal namespaces, the domain name hierarchy and the Internet Protocol (IP) address spaces. The Domain Name System maintains the domain name hierarchy and provides translation services between it and the address spaces. Internet name servers and a communication protocol implement the Domain Name System. A DNS name server is a server that stores the DNS records for a domain; a DNS name server responds with answers to queries against its database.

The most common types of records stored in the DNS database are for Start of Authority (SOA), IP addresses (A and AAAA), SMTP mail exchangers (MX), name servers (NS), pointers for reverse DNS lookups (PTR), and domain name aliases (CNAME). Although not intended to be a general purpose database, DNS can store records for other types of data for either automatic lookups, such as DNSSEC records, or for human queries such as responsible person (RP) records. As a general purpose database, the DNS has also been used in combating unsolicited email (spam) by storing a real-time blackhole list. The DNS database is traditionally stored in a structured zone file.

An often-used analogy to explain the Domain Name System is that it serves as the phone book for the Internet by translating human-friendly computer hostnames into IP addresses. For example, the domain name www.cox.com translates to the address 68.99.123.161 (IPv4). Unlike a phone book, DNS can be quickly updated, allowing a service's location on the network to change without affecting the end users, who continue to use the same host name. Users take advantage of this when they use meaningful Uniform Resource Locators (URLs), and e-mail addresses without having to know how the computer actually locates the services.

An important and ubiquitous function of DNS is its central role in distributed Internet services such as cloud services and content delivery networks. When a user accesses a distributed Internet service using a URL, the domain name of the URL is translated to the IP address of a server that is proximal to the user. The key functionality of DNS exploited here is that different users can simultaneously receive different translations for the same domain name, a key point of divergence from a traditional phone-book view of the DNS. This process of using the DNS to assign proximal servers to users is key to providing faster and more reliable responses on the Internet and is widely used by most major Internet services.

The DNS reflects the structure of administrative responsibility in the Internet. Each subdomain is a zone of administrative autonomy delegated to a manager. For zones operated by a registry, administrative information is often complemented by the registry's RDAP and WHOIS services. That data can be used to gain insight on, and track responsibility for, a given host on the Internet.

Domains and domain names are fundamental to the operation of the Internet. They provide a hierarchy of unique identifiers that guide traffic across the Web and identify websites, servers and other resources. However, in the form of malicious domains, they are a basic tool in the hands of cybercriminals.

As with other aspects of computer security, there are no silver bullets for protecting against malicious domains. However, understanding domain names can help firms and individual employees guard themselves against attacks.

Domain names form a hierarchy of domains and subdomains. For example, marketing.companyname.com is a subdomain of companyname.com. In turn, this is one of the many subdomains of the familiar top-level domain (TLD) com. It is typical to type a period in front of TLD names, as in .com, though the period is technically a separator, not part of the TLD itself.

A recent survey found that the largest single group of malicious domains, about one-third of the total, fall under the TLD .biz. This TLD was created specifically for business use in 2000 to alleviate overcrowding within the original .com TLD (which dates back to the 1980s).

It should be emphasized that most .biz websites are perfectly legitimate businesses. However, the difficulty of policing an entire global TLD has let cybercriminals register domain names that often mimic well-known, legitimate domains, such as the websites of major firms. Most other malicious domains fall under the long-established .org, .com and .net TLDs. Some have country-specific TLDs, often to either target victims in those countries or disguise their own origins.

Effective protection against malicious domains includes user awareness. For example, a domain name such as companyname.com.biz should trigger immediate suspicion. It is deceptively trying to masquerade as a subdomain of the .com TLD when, in fact, it is a subdomain of .biz. Overly clever spellings, such as www.c0x.com, should also raise a red flag. Unfortunately, all too many users have “domain blindness” and pay little or no attention to where they are actually going online. Moreover, mobile devices such as smartphones may hide address bars in order to conserve limited screen space.

Firms and other organizations can use a brute-force method to protect against some malicious domains by blocking entire TLDs. If, for example, a company has no business partners with a .biz subdomain, it can bar all connections to .biz. Individual exceptions can then be white-listed. However, this is not practical for TLDs such as .com or .org. Along with encouraging user awareness, protection may be provided by a security partner that can provide up-to-date listings of malicious domains to avoid. There are heretofore unaddressed needs with these previous protection solutions.

### SUMMARY

Example embodiments of the present disclosure provide systems of malicious domain identification. Briefly described, in architecture, one example embodiment of the system, among others, can be implemented as follows: a processor for executing software; and memory configured to store the software, the software comprising instructions for: selecting a first group of IP addresses with traffic including at least one malicious domain; selecting a second group of IP addresses with traffic including no malicious domains; comparing domains of the traffic of the first group of IP Addresses to domains of the traffic from the second group of IP addresses; and identifying the malicious domains as the domains present in the traffic of the first group of IP addresses and not present in the second group of IP addresses.

Embodiments of the present disclosure can also be viewed as providing methods for malicious domain identification. In this regard, one embodiment of such a method, among others, can be broadly summarized by the following steps: selecting a first group of IP addresses with traffic including at least one malicious domain; selecting a second group of IP addresses with traffic including no malicious domains; comparing domains of the traffic of the first group of IP Addresses to domains of the traffic from the second group of IP addresses; and identifying the malicious domains as the domains present in the traffic of the first group of IP addresses and not present in the second group of IP addresses.

### BRIEF DESCRIPTION OF THE DRAWINGS

FIG. 1 is a system diagram of various levels within a DNS hierarchy.

FIG. 2 is a diagram of a domain name tree.

FIG. 3 is a system diagram of a system and method of query resolution.

FIG. 4 is a diagram of an example embodiment of a system and method of malicious domain identification.

FIG. 5 is an example bar graph of domains and total number of queries using the system and method of FIG. 4.

FIG. 6 is an example bar graph of ratios of queries using the system and method of FIG. 4.

FIG. 7 is an example bar graph of queries in logarithmic scale using the system and method of FIG. 4.

FIG. 8 is flow diagram of an example embodiment of a method of malicious domain identification.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

A set of user IP addresses may be infected with malware or a virus. The common traffic of those IP addresses may be identified to determine the control channel which may be considered to be a malicious domain. A malicious domain supports malware, short for malicious software, which is any software used to disrupt computer or mobile operations, gather sensitive information, gain access to private computer systems, or display unwanted advertising. Previous approaches have examined all the DNS requests that are received by those IP addresses and commonalities are determined. This approach may not work because many host names may start with the same prefix. If, for example, 100 users are sampled, 80-90 of them may be accessing domains such as Google and Facebook resulting in instances of the malicious domain being drowned out by the legitimate traffic.

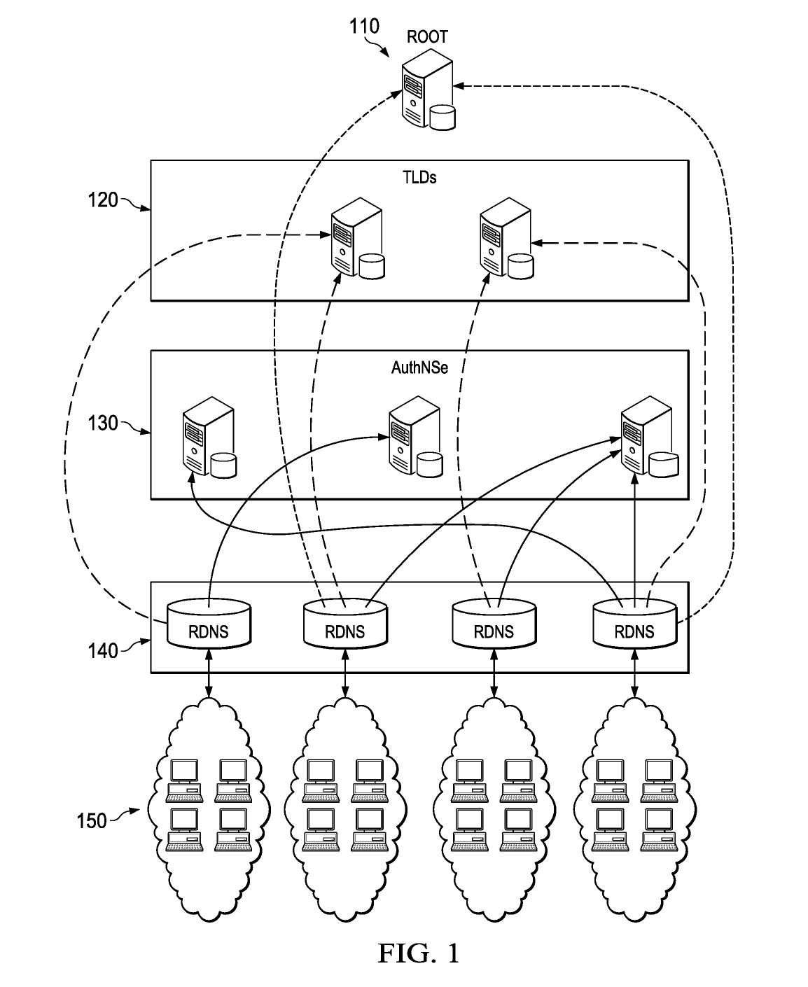

FIG. 1 illustrates a various levels within a DNS hierarchy, including root 110, TLDs 120, AuthNSe 130, RDNS 140, and querying users 150. Root 110 is the top-level DNS zone in the hierarchical namespace of the Domain Name System (DNS) of the Internet. The DNS root zone is served by thirteen root server clusters which are authoritative for queries from querying users 150 to the top-level domains 120 of the Internet. Thus, every name resolution either starts with a query to a root server, or, uses information that was once obtained from a root server. Top-level domains 120 are installed in the root zone of the name space. For all domains in lower levels, it is the last part of the domain name, that is, the last label of a fully qualified domain name. For example, in the domain name www.cox.com, the top-level domain is corn. Authoritative name server 130 provides answers to DNS queries such as mail server IP address or web site IP address (a resource record). AuthNSe 130 provides original and definitive answers to DNS queries. It does not provide cached answers that were obtained from another name server. Therefore it only returns answers to queries about domain names that are installed in its own configuration system. Reverse DNS resolution server 140 answers queries of the Domain Name System (DNS) to determine the domain name associated with an IP address—the reverse of the usual “forward” DNS lookup of an IP address from a domain name.

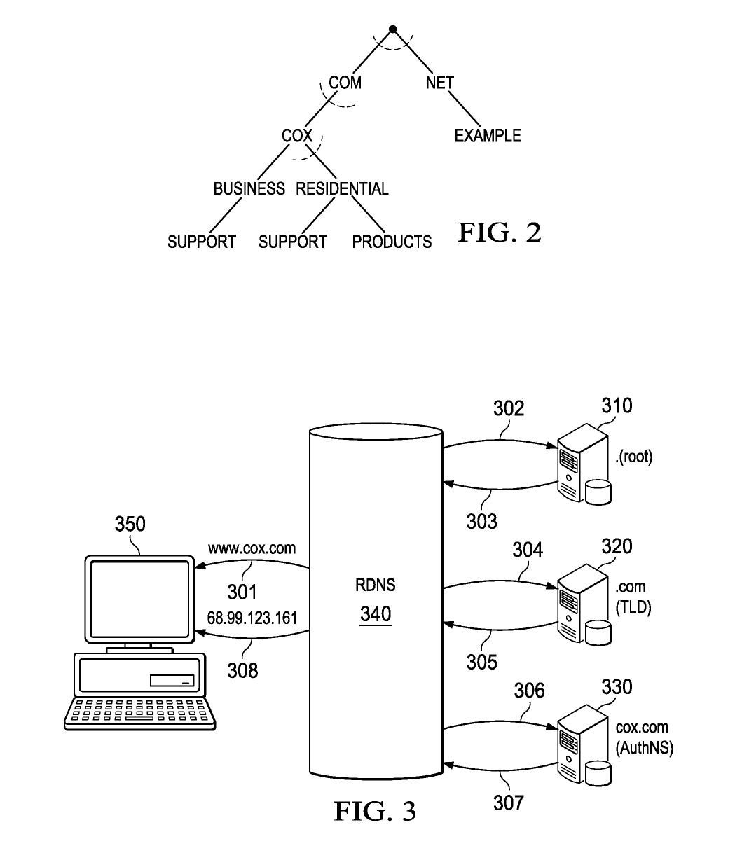

FIG. 2 provides an example of a domain name tree. The Internet domain name system is structured like a tree and a domain name can identify a node in the tree. Each node or leaf in the tree has a label and zero or more resource records (RR), which hold information associated with the domain name. The domain name itself consists of the label, possibly concatenated with the name of its parent node on the right, separated by a dot. The tree sub-divides into zones beginning at the root zone. A DNS zone may consist of only one domain, or may consist of many domains and sub-domains, depending on the administrative choices of the zone manager. DNS can also be partitioned according to class; the separate classes can be thought of as an array of parallel namespace trees.

FIG. 3 provides an example of a system and method of query resolution. In step 301, user 350 requests the web page at www.cox.com. In step 302, RDNS resolver 340 requests a referral for www.cox.com from root node server 310. In step 303, root node server 310 provides a delegation for www.cox.com to .com TLD node server 320. In step 304, RDNS resolver 340 requests a referral for www.cox.com from .com TLD node server 320 and, in step 305, .com TLD node server 320 refers RDNS resolver 340 to authenticator node server 330 for cox.com. In step 306, RDNS resolver 340 requests a referral for www.cox.com from authenticator node server 330 and, in step 307, RDNS resolver 340 receives the DNS resolution for the domain name www.cox.com. In step 308, RDNS resolver 340 provides the DNS resolution for the domain name www.cox.com to user 350.

U.S. Pat. No. 8,631,489 for a Method and System for Detecting Malicious Domain Names at an Upper DNS Hierarchy utilizes collected domain name statistical information to determine if a domain is malicious or benign. The statistical information used includes a requester diversity vector, a requester profile vector, and a requester reputation vector. This method examines a large number of DNS lookups and performs statistical analysis to determine which ones are malicious. One can then back track to find out which clients looked up those domains. Example embodiments of the systems and methods of malicious domain identification disclosed herein start with clients that are exhibiting malicious behavior and determine what malicious domain they are querying.

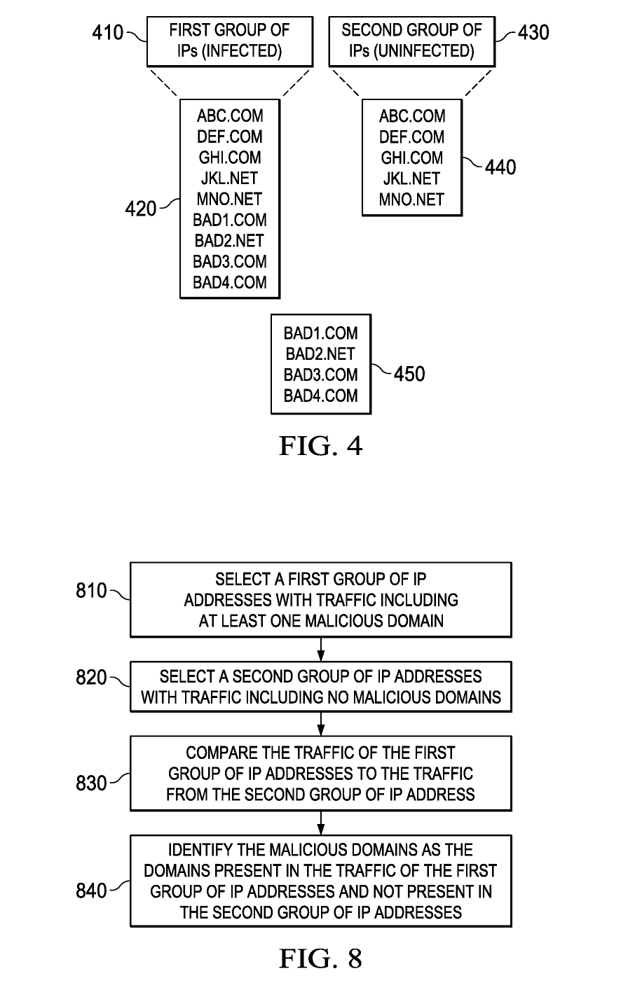

Example embodiments of the systems and methods of malicious domain identification disclosed herein considers, as provided in FIG. 4, first group of users 410. First group of users 410 has traffic 420 including some traffic with malicious domains. Second group of users 430 is then selected with traffic 440 that is known to be uninfected, and the common domains are determined. Second group of users 430, who are known to be uninfected users, are accessing Facebook and Google, among others, but are not accessing the malicious domains. Traffic 440 from second group of users 430 will have the same commonalities between each other as the malicious domain does with second group 440. The common domains between first and second groups 410, 430 are determined and eliminated. When the common domains are removed from traffic 420 of first group of users 410, malicious domain list 450 remains.

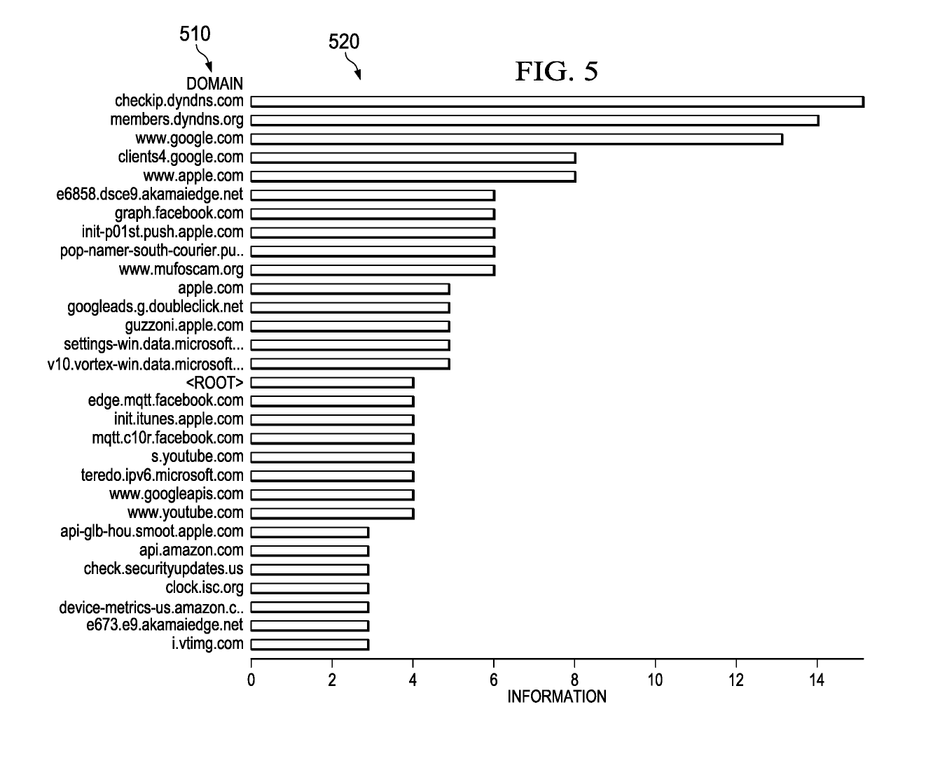

Given a set of known infected hosts, the DNS lookups performed by those hosts may be examined to find control channels. The traffic from the infected hosts may be sampled and the number of hosts querying each hostname counted. A naïve approach would be to simply create a histogram of the number of infected hosts querying a particular domain. However, many of the infected hosts may also have non-malicious domains in common. FIG. 5 provides a graph of domains 510 and total number of queries 520. In order to eliminate non-malicious domains from domains 510, data from an additional set of known non-infected hosts are sampled. Since the additional set may not be empirically known to be 100% clean from malicious domains, a statistically large population may be chosen to reasonably assume an approximation of “uninfected.” As an example, the surrounding /24s of all the infected /32s may be used. In this example, “/24” is a notation that means 255 IP addresses. For example, 68.3.0.0/24 refers to the IP addresses 68.3.0.0 through 68.3.0.255. A /32 is a single IP address. So if, for example, the infected client was 68.3.4.5, all the other 68.3.4.x hosts would be compared.

With a set of domains and counts for both the infected and uninfected sets, data from the uninfected set that does not exist in the infected set may be eliminated. For example, if an uninfected host looked up www.somesite.com but no infected host did, www.somesite.com may be eliminated from the results. The count of hosts looking up a particular name does not directly help because the sizes of the two sets are different. Instead, the percentage of hosts in each set looking up a particular domain is calculated. If any site in the infected set is not queried at all by the uninfected set, it may treated as if one host had looked it up in order to avoid dividing by zero in the next step.

In an example embodiment of the systems and methods of malicious domain identification disclosed herein, in order to find the prevalence of a hostname in the infected set relative to the prevalence in the larger uninfected set, the ratio of the percentage of infected hosts looking up a hostname is compared to the percentage of uninfected hosts looking up the same hostname. That ratio of ratios is directly proportional to the number of hosts in the infected set querying the name and inversely proportional to the number of hosts querying it in the uninfected set.

In an example implementation, a sample set may include 59 infected hosts and 9344 uninfected hosts during a 5 minute sample window. In the example, www[.]mufoscam[.]org, a malicious domain, was queried by 6 hosts in the infected set. The numerator is thus 6/59. In this example, www[.]mufoscam[.]org was also queried by 0 hosts in the infected set, which is treated as 1, and the denominator is thus 1/9344. The ratio for www[.]mufoscam[.]org is then (6/59)/(1/9344), which results in approximately 950. A non-malicious domain in the same sample set includes www.apple.com, which was queried by 8 out of 59 infected hosts, which is higher than queries of any of the malicious domains. However, www.apple.com was queried by 1483 out of 9344 uninfected hosts. The score for www.apple.com is therefor (8/59)/(1483/9344), which results in approximately 0.85.

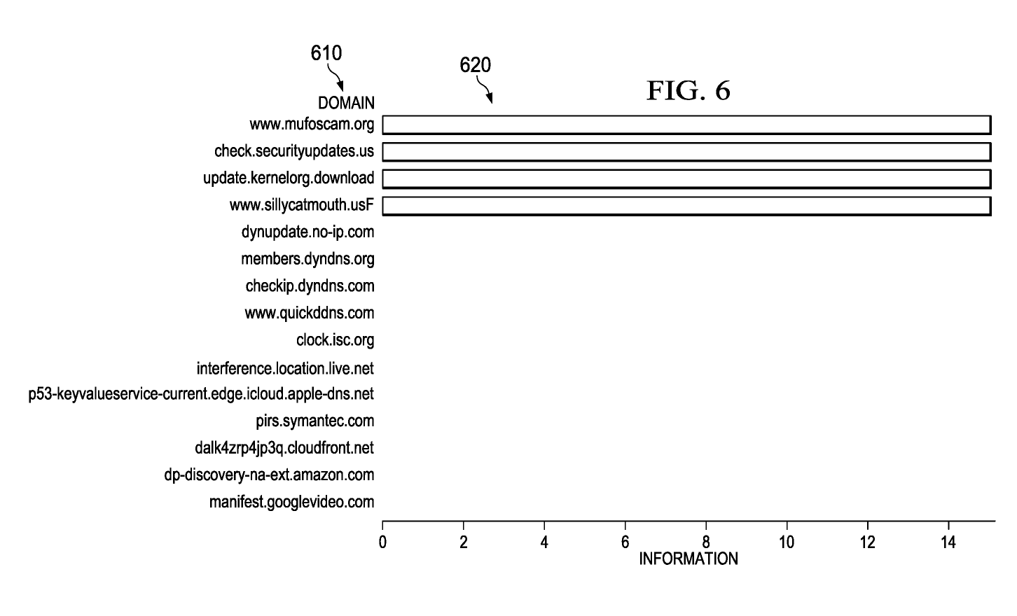

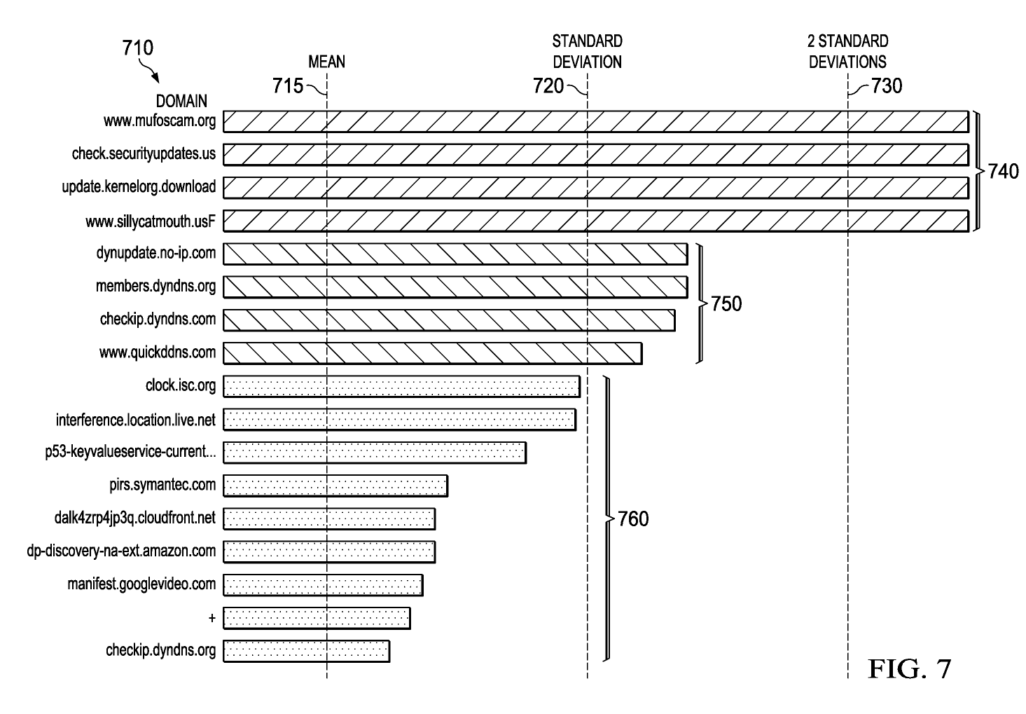

A resulting graph of the ratio of ratios is provided in FIG. 6 with domains 610 and corresponding ratios 620. The ratios of malicious and non-malicious domains are easily discernible. The results are much more interesting with a log scale as provided in FIG. 7 with domains 710, mean ratio 715, ratios outside of one standard deviation from the mean 720, and ratios outside of two standard deviations from the mean 730. Domains 740 outside of two standard deviations from the mean 730 correspond to malicious domains. Domains 750 outside of one standard deviation from the mean 720 correspond to domains that are associated with malware but not necessarily malicious themselves. Domains 760 correspond to non-malicious domains.

FIG. 8 provides a flow chart of an example embodiment of a method of malicious domain identification. In block 810, a first group of IP addresses with traffic including at least one malicious domain is selected. In block 820, a second group of IP addresses with traffic including no malicious domains is selected. In block 830, the traffic of the first group of IP addresses is compared to the traffic from the second group of IP addresses. In block 840, the malicious domains are identified as the domains present in the traffic of the first group of IP addresses and not present in the traffic of the second group of IP addresses.

The flow chart of FIG. 8 shows the architecture, functionality, and operation of a possible implementation of the malicious domain identification software. In this regard, each block represents a module, segment, or portion of code, which comprises one or more executable instructions for implementing the specified logical function(s). It should also be noted that in some alternative implementations, the functions noted in the blocks may occur out of the order noted in FIG. 8. For example, two blocks shown in succession in FIG. 8 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present disclosure has been described in detail, it should be understood that various changes, substitutions and alterations can be made thereto without departing from the spirit and scope of the disclosure as defined by the appended claims.

Therefore, at least the following is claimed:

1. A method comprising:
selecting a first group of IP addresses with traffic including at least one malicious domain;
selecting a second group of IP addresses with traffic including no malicious domains;
comparing domains of the traffic of the first group of IP Addresses to domains of the traffic from the second group of IP addresses; and
identifying the malicious domains as the domains present in the traffic of the first group of IP addresses and not present in the second group of IP addresses.

2. The method of claim 1, wherein the second group of IP addresses is controlled by an internet service provider.

3. The method of claim 1, further comprising eliminating domains from traffic from the second group of IP addresses that is not present in the first group.

4. The method of claim 1, wherein comparing the domains of the traffic of the first group of IP addresses to the domains of the second of the traffic of the second group of IP addresses comprises determining a percentage of IP addresses in each of the first and second groups accessing a particular domain.

5. The method of claim 4, further comprising determining a ratio of the percentages for a particular domain accessed by the first group of IP addresses and the second group of IP addresses.

6. The method of claim 5, wherein, if an IP address does not access a particular domain, then assigning the instances of access for that domain as one.

7. The method of claim 5, further comprising determining malicious domains by examining the ratios on a log scale.

8. A tangible computer readable medium comprising software, the software comprising instructions for:
selecting a first group of IP addresses with traffic including at least one malicious domain;
selecting a second group of IP addresses with traffic including no malicious domains;
comparing domains of the traffic of the first group of IP Addresses to domains of the traffic from the second group of IP addresses; and
identifying the malicious domains as the domains present in the traffic of the first group of IP addresses and not present in the second group of IP addresses.

9. The computer readable medium of claim 8, wherein the second group of IP addresses is controlled by an internet service provider.

10. The computer readable medium of claim 8, wherein the software further comprises instructions for eliminating domains from traffic from the second group of IP addresses that is not present in the first group.

11. The computer readable medium of claim 8, wherein instructions for comparing the domains of the traffic of the first group of IP addresses to the domains of the second of the traffic of the second group of IP addresses comprises instructions for determining a percentage of IP addresses in each of the first and second groups accessing a particular domain.

12. The computer readable medium of claim 11, wherein the software further comprises instructions for determining a ratio of the percentages for a particular domain accessed by the first group of IP addresses and the second group of IP addresses.

13. The computer readable medium of claim 12, wherein, if an IP address does not access a particular domain, then assigning the instances of access for that domain as one.

14. The computer readable medium of claim 12, wherein the software further comprises determining malicious domains by examining the ratios on a log scale.

15. A system, comprising:
a processor for executing software; and
memory configured to store the software, the software comprising instructions for:
selecting a first group of IP addresses with traffic including at least one malicious domain;
selecting a second group of IP addresses with traffic including no malicious domains;
comparing domains of the traffic of the first group of IP Addresses to domains of the traffic from the second group of IP addresses; and
identifying the malicious domains as the domains present in the traffic of the first group of IP addresses and not present in the second group of IP addresses.

16. The system of claim 15, wherein the second group of IP addresses is controlled by an internet service provider.

17. The system of claim 15, wherein the software further comprises instructions for eliminating domains from traffic from the second group of IP addresses that is not present in the first group.

18. The system of claim 15, wherein instructions for comparing the domains of the traffic of the first group of IP addresses to the domains of the second of the traffic of the second group of IP addresses comprises instructions for determining a percentage of IP addresses in each of the first and second groups accessing a particular domain.

19. The system of claim 18, wherein the software further comprises instructions for determining a ratio of the percentages for a particular domain accessed by the first group of IP addresses and the second group of IP addresses.

20. The system of claim 19, wherein the software further comprises determining malicious domains by examining the ratios on a log scale.
